(19) United States
(12) Patent Application Publication
(10) Pub. No.: US 2010/0103893 A1
(43) Pub. Date: Apr. 29, 2010

(54) SPATIAL DIVISION MULTIPLE ACCESS WIRELESS COMMUNICATION SYSTEM

(75) Inventors: Pengfei Xia, Mountain View, CA (US); Su-Khiong Yong, Santa Clara, CA (US); Chiu Ngo, San Francisco, CA (US)

Correspondence Address: Myers Andras Sherman LLP, 19900 MacArthur Blvd., Suite 1150, Irvine, CA, 92612, US

(73) Assignee: Samsung Electronics Co., Ltd., Suwon City (KR)

(21) Appl. No.: 12/539,515

(22) Filed: Aug. 11, 2009

Related U.S. Application Data
(60) Provisional application No. 61/109,435, filed on Oct. 29, 2008.

(51) Int. Cl. H04W 72/00

(52) U.S. Cl. 370/329

(57) ABSTRACT

A method and system for wireless communication in a network of wireless devices, is disclosed. The network includes multiple stations (STAs) and an access point (AP). Each wireless device includes plural antennas. In one embodiment, multiple stations accessing the access point at the same time using a spatial division multiple access (SDMA) protocol. The SDMA protocol involves performing an iterative antenna training process for obtaining principle singular vectors for beamforming communication over a wireless channel without explicit knowledge of the channel.

### RELATED APPLICATION

This application claims priority from U.S. Provisional Patent Application Ser. No. 61/109,435, filed on Oct. 29, 2008, incorporated herein by reference.

### FIELD OF THE INVENTION

The present invention related generally to wireless communication, and in particular, to spatial division multiple access (SDMA).

### BACKGROUND OF THE INVENTION

Wireless communication in 60 GHz frequency band calls for transceiver beamforming due to large link budget deficit. Spatial division multiple access (SDMA) radio multiple access communication, used in cellular communication systems, provides a communication channel using parallel spatial pipes next to higher capacity pipes using spatial multiplexing and/or diversity. Typically, SDMA cellular communications involve multiple devices, each device equipped with several antennas, although the number of antennas is not large (is in the order of 2 to 6 antennas per device). In such cases, multiple input multiple output (MIMO) wireless channels are explicitly estimated at an base station (BS) device and optimal (or near optimal) beamforming vectors for all the devices are determined. As such, an estimate-and-feedback approach is utilized for the SDMA scenario. In a network including multiple wireless devices such as two wireless stations and an access point (AP), where each of the wireless stations and the access point include a large number of antennas (e.g., a 36 element antenna array), large vector matrices must be estimated. For example, for a 36 element antenna array, two vector matrices of size 36×36 need to be estimated, where a total of 2592 complex channel elements need to be estimated.

### BRIEF SUMMARY OF THE INVENTION

The present invention provides a method and system for wireless communication in a network of wireless devices. The network includes multiple stations (STAs) and an access point (AP), each wireless device including plural antennas. In one embodiment, multiple stations access the access point at the same time using a spatial division multiple access (SDMA) protocol. The SDMA protocol includes performing an iterative antenna training process for obtaining principle singular vectors for beamforming communication over a wireless channel without explicit knowledge of the channel.

The wireless network may comprises a 60 GHz Millimeter Wave wireless network, and the iterative antenna training process may comprise estimating antenna beamforming vectors for the stations accessing the access point using beamforming.

The iterative antenna training process may further comprise the stations transmitting training sequences to the access point at the same time using orthogonal (or near orthogonal) spreading sequences for each station to reduce interference, by repeating destination beamforming vector training and source beamforming vector training over multiple iterations. In each iteration step, a normalized beamforming vector outcome r is used for training of source beamforming vector, and a normalized beamforming vector outcome t is used in the next iteration for training of destination beamforming vector.

Each iteration step may further include transmitting a vector t in a given time slot by sending a predetermined pseudo random sequence spatially spread by vector t, and transmitting a vector r in a given time slot by sending a predetermined pseudo random sequence spatially spread by vector r.

The iterative antenna training process may further comprise repeating STA-side antenna training and AP-side antenna training steps multiple times. AP transmits orthogonal BF vectors and which are spread by respective orthogonal pseudo random spreading sequences. The normalized interim transmit beamforming vectors v, w obtained in each iteration for the first and second stations, respectively, are used in AP-side antenna training step in the current iteration step. The normalized interim receive beamforming vectors u₁, u₂ obtained in each iteration step for the AP, respectively, are used in STA-side antenna training in a next iteration step.

A first station includes an N-element antenna array, and a second station includes an M-element antenna array, and an AP includes a K-element antenna array. STA-side training may include repeatedly transmitting from a first radio frequency (RF) chain of an AP the same initial receive beamforming vector u₁ for a first station for N consecutive channel time slots, while each time slot is spread by a pseudo random spreading sequence p₁. Repeatedly transmitting from a second RF chain of an AP the same initial receive beamforming vector u₂ for a second station for M consecutive channel time slots, while each time slot is spread by a pseudo random spreading sequence p₂, wherein p₂ is essentially orthogonal (or near orthogonal) to p₁. The first station using I_{N} as a receive beamforming vector over N time slots, while performing de-spreading using p₁. The second station using I_{M} as a receive beamforming vector over M channel time slots, while performing de-spreading using p₂. And, collecting the received samples, and estimating transmit beamforming vectors v, w for first and second stations, respectively.

AP-side training may include repeatedly transmitting the same normalized vector v over K channel time slots from the first station while each time slot is spread by a pseudo random sequence q₁. Repeatedly transmitting the same normalized vector w over K channel time slots from the second station while each time slot is spread by a pseudo random sequence q₂, that is essentially orthogonal (or near orthogonal) to q₁. In a first RF chain of the AP using I_{K} as the receive beamforming vector over K time slots while de-spreading using q₁. In a second RF chain of the AP using J_{K} as the receive beamforming vector over K time slots while de-spreading using q₂, wherein J_{K} is selected as an orthogonal matrix such that each column of J_{K} is orthogonal to the corresponding column of I_{K}. Collecting and rearranging samples for estimating vectors u₁, u₂. And, using beamforming vectors u₁, u₂ in the next iteration of station-side antenna training

These and other features, aspects and advantages of the present invention will become understood with reference to the following description, appended claims and accompanying figures.

### BRIEF DESCRIPTION OF THE DRAWINGS

FIG. 1 shows a functional block diagram of a wireless communication system including multiple wireless stations (STAs) and a wireless access point (AP), implementing a spatial division multiple access (SDMA) protocol, according to an embodiment of the invention.

FIG. 2 graphically illustrates an antenna training process for spatial division multiple access, according to an embodiment of the invention.

FIG. 3 shows an iteration process utilizing a spreading sequence for each step of the iterative protocol and normalization of the received vector to obtain interim vector, according to an embodiment of the invention.

FIG. 4 illustrates an example STA-side antenna training process, according to an embodiment of the invention.

FIG. 5 illustrates an example AP-side antenna training process, according to an embodiment of the invention.

FIG. 6 shows an example overall timing sequence for antenna training, according to an embodiment of the invention.

FIG. 7 illustrates numerical performance comparisons, according to an embodiment of the invention.

FIG. 8 shows a functional block diagram of a wireless communication system including multiple STAs and a wireless AP, implementing a spatial division multiple access (SDMA) protocol for 60 GHz Millimeter Wave Communications for 60 GHz wireless network, according to an embodiment of the invention.

### DETAILED DESCRIPTION OF THE INVENTION

The present invention provides a method and system for wireless communication in networks with a large number of antennas and a small number of radio frequency (RF) chains. One embodiment employs a spatial division multiple access (SDMA) protocol for 60 GHz Millimeter Wave Communications for 60 GHz wireless networks.

In one implementation, the invention provides a practical antenna training protocol for 60 GHz SDMA networks for acquiring the antenna beamforming coefficients where more than one wireless station (STA) attempt access to a common access point (AP) using iterative beamforming. The actual wireless channels need not be explicitly estimated in acquiring the beamforming coefficients. Furthermore, the overall training overhead and complexity is proportional to the number of RF chains, instead of the number of antenna elements. As such, the iterative training protocol disclosed herein is specially suitable for networks with a large number of antenna elements and a small number of RF chains, as is typical for 60 GHz beamformed networks. In one example, a large number of antennas can range from greater than 4 to 64, and small number of RF chains (in relation to number of antennas) can range in 2 to 4.

An example 60 GHz network of wireless devices according to the invention implements a wireless communication protocol including training antenna coefficients for each wireless device in the network. Three or more wireless devices are involved (e.g., two STAs and the AP), which is fundamentally different from a point-to-point system where only two devices are involved. A large number of antennas are typically available in each wireless device, wherein the number of antenna elements is much larger than the number of RF chains in each device. An embodiment of the training comprises antenna training by beamforming that enables SDMA. An iterative antenna training protocol for the 60 GHz SDMA network is described hereinbelow.

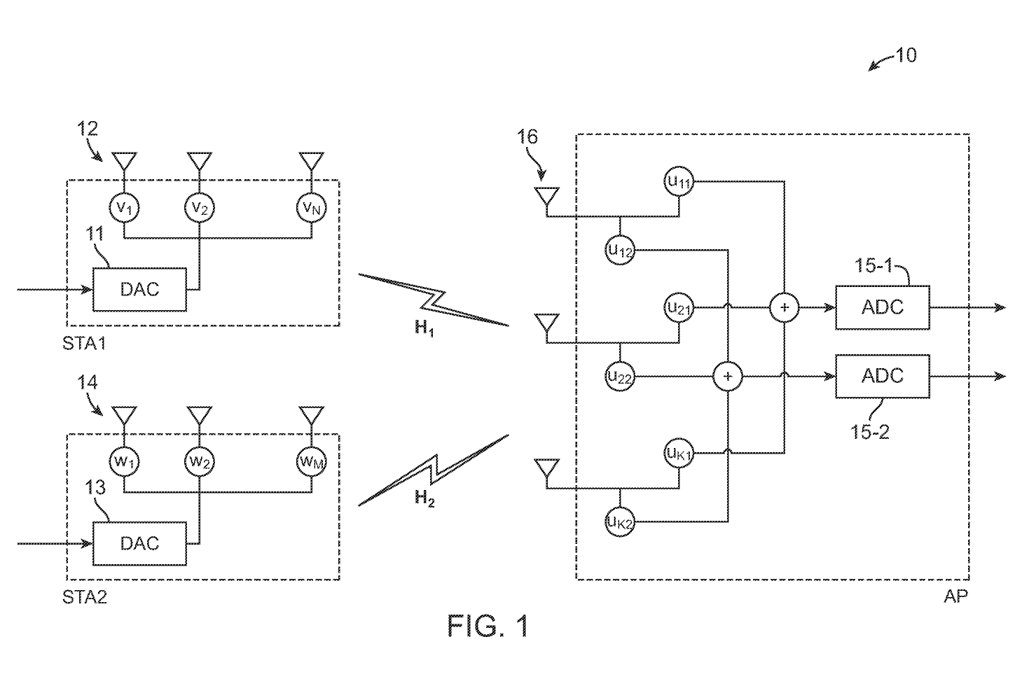

FIG. 1 shows a functional block diagram of a 60 GHz SDMA wireless network 10, according to an embodiment of the invention. The network 10 comprises at least three wireless devices including wireless stations STA1, STA2 and a common access point (AP). The devices STA1 and STA2 access the AP at the same time using SDMA. An RF chain may include a processing chain comprising a forward error correction (FEC) encoder, an interleaver, a constellation mapper (such as Quadrature Amplitude Modulation (QAM) mapper), an OFDM modulator and digital-to-analog converter (DAC) or analog-to-digital converter (ADC) depending on transmitter or receiver.

Each STA has a single RF chain while the AP has two RF chains to support simultaneous transmissions with the two STAs. STA1 includes an RF chain comprising digital-to-analog converter (DAC) 11 and with an N-element antenna array 12, STA2 includes an RF chain comprising a DAC 13 and M-element antenna array 14, while the AP is comprises two analog-to-digital (ADC) converters 15-1, 15-2 and a K-element antenna array 16.

Antenna array beamforming is used to increase link budget and signal quality, and to extend the communication range by steering the transmitted signal in a narrow beam direction. To enable wireless links between a wireless transmitter and a wireless receiver over wireless channels, essentially optimal transmit and receive analog beamforming vectors (beamforming coefficients) are acquired in advance. Transmit and received beamforming use the channel information for determining beamforming coefficients (beamforming vectors) to properly steer the beams into the desired transmission and receiving direction. A process for acquiring such beamforming vectors using power iteration is provided, involving iterative acquisition of the beamforming vectors based on power iteration. In this description, bold-face upper and lower case letters denote matrices and column vectors, respectively, and (.)′ denotes Hermitian transpose.

The uplink (from each STA to the AP) input-output relationship can be described as:

y₁=u′₁H₁v.s₁+n₁

y₂=u′₂H₂w.s₂+n₂

where H₁ represents a K by N (K×N) channel matrix between STA1 and the AP, and H₂ represents a K by M (K×M) channel matrix between STA2 and the AP. Further, u₁=[u₁₁, . . . , u_{K1}]^{T} represents a receive beamforming vector (coefficients) for STA1, and u₂=[u₁₂, . . . , u_{K2}]^{T} represents a receive beamforming vector (coefficients) for STA2. In addition, v=[v₁, . . . , v_{N}] and w=[w₁, . . . , w_{M}] represent transmit beamforming vectors for STA1 and STA2 respectively, and s₁, s₂ represents information symbols originating from STA1 and STA2, respectively. Finally, y₁, y₂, represents received symbols at the output of the two ADCs 15-1, 15-2, of the AP, respectively, and n₁, n₂ represent independent additive white Gaussian random variables for STA1 and STA2, respectively.

In determining the beamforming vectors u₁, u₂, v, w, the number of available antenna elements (N, M or K) may be significantly larger than the number of RF chains. Conventional estimate-and-feedback approaches are inefficient, as the training overhead and complexity is proportional to the number of antenna elements. Instead, according to an embodiment of the invention, power iteration principles are used in determining the beamforming coefficients for STAs and the AP.

Spreading sequences may be used in boosₜing signal-to-noise-ratio (SNR) for beamforming coefficient estimation. Different from a point-to-point scenario where only one STA is involved, in the network 10 two or more STAs transmit training sequences at the same time. As such, orthogonal (or near orthogonal) spreading sequences are allocated for each STA during each antenna training step.

To reduce interference, in a spread-spectrum communication network, the transmitted signal is spread over a wide frequency band, typically much wider than the minimum bandwidth required to transmit the data. The spreading uses a pseudo-random waveform. The input data is multiplied by a pseudo-random (pseudo-noise) sequence, the bit rate of which is much higher than the data bit rate. As such, the data bit rate is increased while adding redundancy (spreading factor is the ratio of the sequence bit rate to the data rate). Upon receiving the signal, de-spreading removes the spreading from the desired signal by multiplying it by the same pseudo-random sequence synchronized to the transmitted pseudo-random signal. When de-spreading operation is applied to interfering signals, there is essentially minimal contribution to the level of signal of interest.

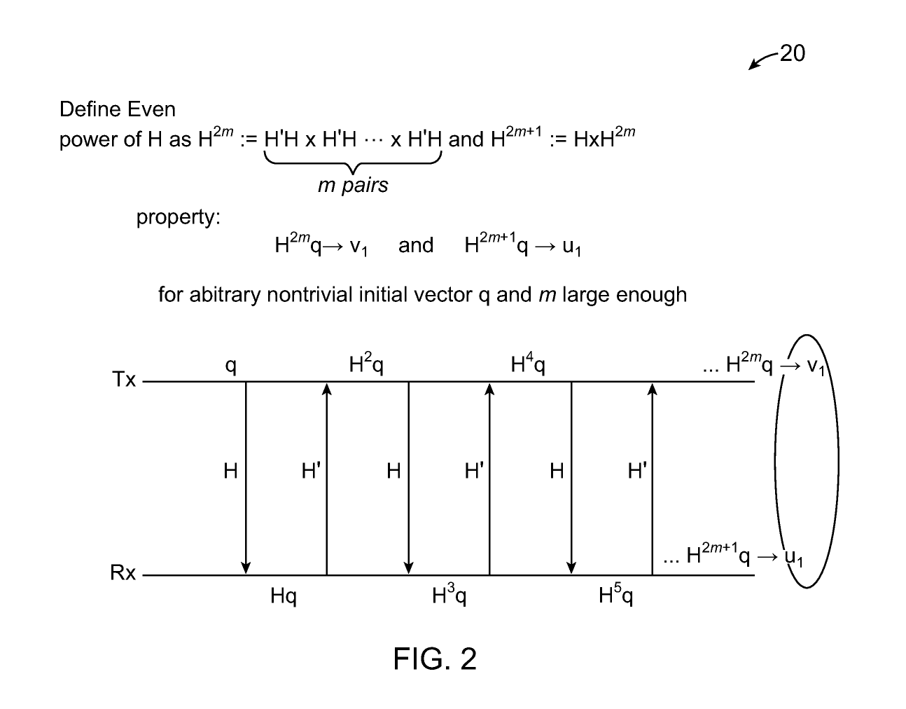

FIG. 2 graphically illustrates a power iteration principle 20 according to the invention. The training process involves obtaining principle singular vectors without explicit knowledge of the channel, wherein cooperation between transmitter and receiver is utilized. Estimating the entire channel is not required. Overall complexity is reduced especially when number of antennas are much larger than number of RF chains.

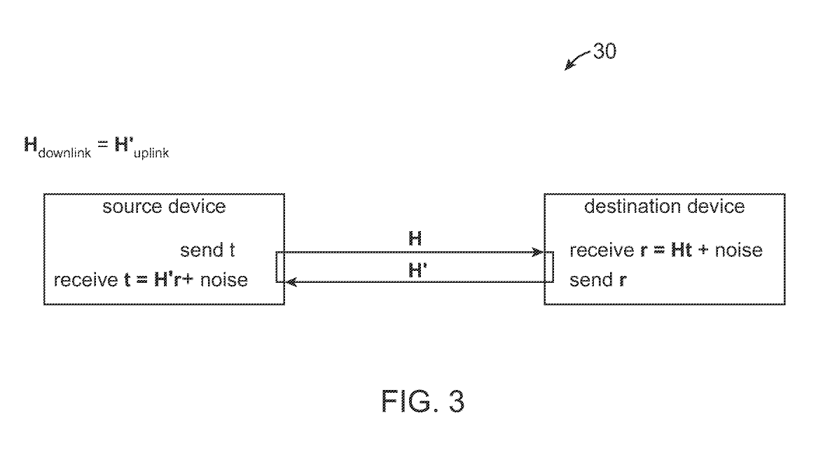

FIG. 3 shows an iteration process 30 utilizing a spreading sequence for each step of the iterative protocol. For destination beamforming vector training, the same vector t is transmitted from the source device over K time slots. In the meantime, I_{K} is used as the receive beamforming matrix at the destination device which means that the first column of I_{K} is used as the receive beamforming vector in the first time slot, the second column of I_{K} is used as the receive beamforming vector in the second time slot, and so on and so forth. At the destination device the vector r can be determined as:

r=Ht+noise.

Use of a spreading sequence improves the estimation SNR and the use of power iteration, allowing estimating beamforming coefficients iteratively without explicit knowledge of H. In one implementation, given the low operating SNR before the final beamforming vector is acquired, use of temporal spreading allows boosting the estimation SNR. A pseudo random spreading sequence may be used for iterative training purpose. Therefore, in a training step sending a certain vector t in a given time slot actually means sending a predetermined pseudo random sequence spatially spread by vector t. This applies to later training steps as well.

For source device beamforming vector training, the same vector r is sent repeatedly (after normalization) from the destination device over N time slots. In the meantime, I_{N} is used as the receive beamforming matrix at the source device, wherein:

t=H′r+noise=H²t+noise.

The iterative process involves repeating destination beamforming vector training and source beamforming vector training m times, where: in step (1) the outcome beamforming vector r after normalization in each iteration step is used in the next step (2) for source beamforming vector training, and in step (2) the outcome beamforming vector t, after normalization, is used in step (1) of the next iteration for destination beamforming vector training Vector normalization is utilized in each iteration when updated vectors t or r are transmitted. Vector r at the destination device converges to the desired singular vector u₁, while vector t at the source device converges to the desired singular vector u₂. An implementation of the iterative training process is described below.

### Power Iterative Antenna Training Protocol for SDMA

An iterative antenna training protocol for a time division duplex (TDD) network, wherein the uplink (from each STA to AP) and downlink (from AP to each STA) channels are reciprocal based on calibrated RF, is disclosed. For simplicity, and without loss of generality, it is assumed in one example that N≧M.

### Initialization

Select a random pair of orthogonal, non-zero vectors u₁⊥u₂ wherein ⊥ indicates orthogonal.

### STA-Side Antenna Training (Destination Beamforming Vector Training)

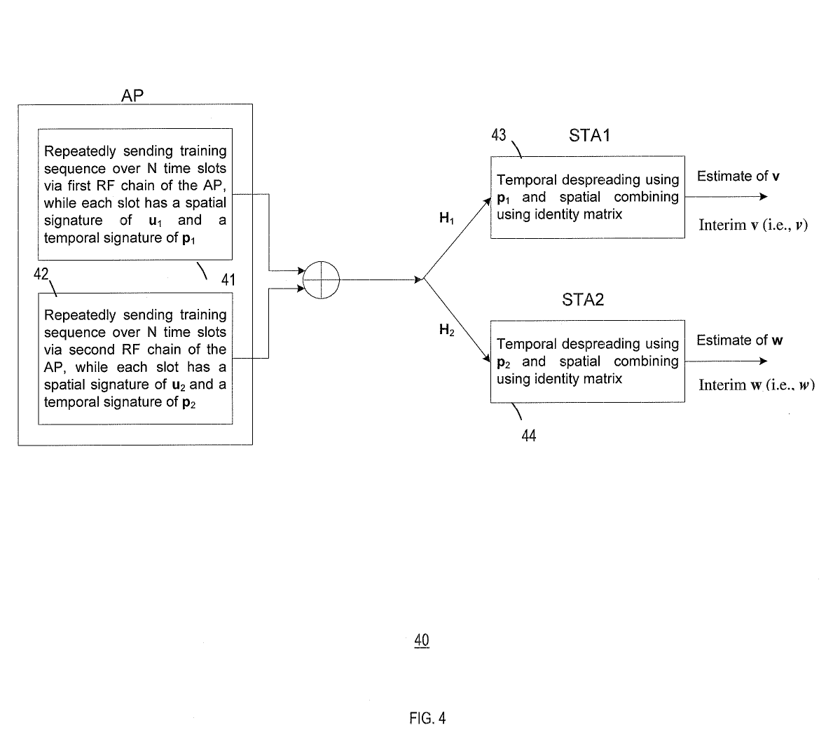

FIG. 4 illustrates an example of STA-side antenna training process 40. In processing block 41, the same initial vector u₁ is repeatedly transmitted for N consecutive channel time slots from the first RF chain of the AP (i.e., via ADC 15-1), while each time slot is spread by a pseudo random spreading sequence p₁. In processing block 42, the same vector u₂ is repeatedly transmitted over M consecutive channel time slots from the second RF chain of the AP (i.e., via ADC 15-2), while each time slot is spread by a pseudo random spreading sequence p₂, that is (near) orthogonal to p₁. In processing block 43, at STA1 side, use I_{N} as the receive beamforming vector (matrix) over N time slots, while de-spreading using p₁ is performed. In the meantime, in processing block 44, at STA2 side, use I_{M} as the receive beamforming vector (matrix) over M channel time slots, while de-spreading using p₂ is performed. The received samples at each STA (i.e., samples v and w which are also the estimated beamforming vectors for STA1 and STA2, respectively) are collected, and interim beamforming vectors v, w are estimated as:

v=H′₁(u₁⊕u₂)+noise

w=H′₂(u₁⊕u₂)+noise

where H′₁ is the Hermition transpose of channel H₁, and ⊕ indicates that u₁ is spread by sequence p₁ and u₂ is spread by sequence p₂ before they are added in the wireless communication medium (e.g., air), and corresponding de-spreading is employed at STA sides. As a result, interim transmit beamforming vectors v, w for STA1, STA2, respectively, are estimated.

### AP-Side Antenna Training (Source Beamforming Vector Training)

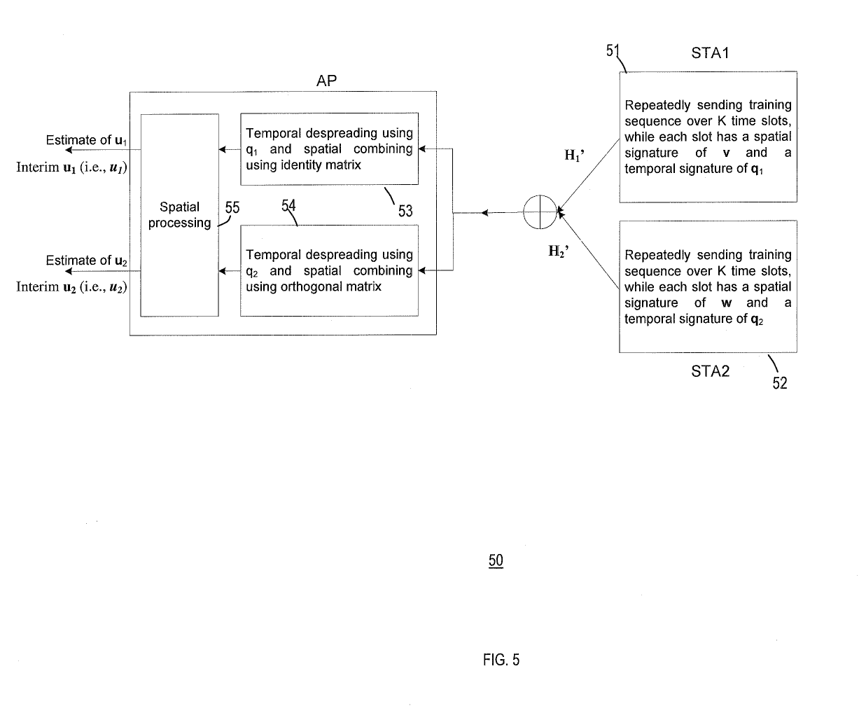

FIG. 5 illustrates an example of AP-side antenna training process 50. In processing block 51, the same interim vector v is repeatedly transmitted, after normalization, over K channel time slots from STA1 while each time slot is spread by a pseudo random sequence q₁. In processing block 52, the same interim vector w, after normalization, is repeatedly transmitted over K channel time slots from STA2 while each time slot is spread by a pseudo random sequence q₂, that is (near) orthogonal to q₁.

For the first RF chain of the AP, in processing block 53 use I_{K} as the receive beamforming matrix over K time slots while de-spreading using q₁ is performed. For the second RF chain of the AP, in processing block 54 use J_{K} as the receive beamforming matrix over K time slots while de-spreading using q₂ is performed. J_{K} is selected as an orthogonal matrix such that each column of J_{K} is orthogonal to the corresponding column of I_{K}. After block 55, the received samples at the AP are collected and rearranged (i.e., received samples are u₁ and u₂ are rearranged by providing u₁ and u₂ to the appropriate RF chains for processing), wherein further interim vectors u₁, u₂ are estimated as:

u₁=H₁v+interference+noise

u₂=H₂w+interference+noise

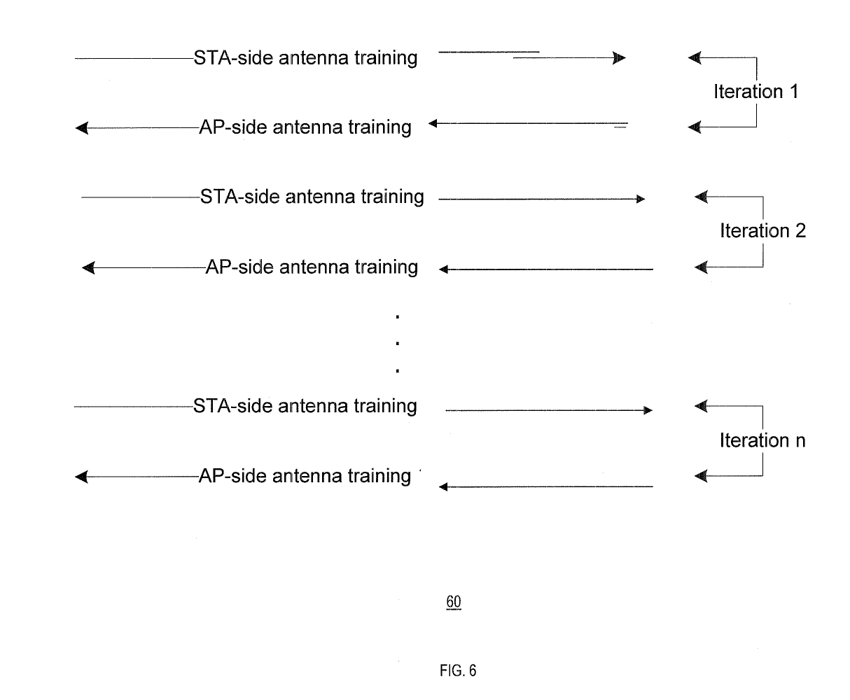

The interim beamforming vectors u₁, u₂ are used in the next iteration of STA-side antenna training above. FIG. 6 shows the overall timing sequence 60 for the training period.

The iterative process for the antenna training period involves repeating STA-side antenna training and AP-side antenna training steps above a number of times (e.g., m=3 or 4 iterations), wherein the obtained interim vectors v, w, after normalization, in each iteration are used in AP-side antenna training step in the next iteration. Similarly, interim vectors u₁, u₂, after normalization, in each iteration are used in the next STA-side antenna training An example condition for termination of iteration is when the beamforming weight vectors converge and that typically when the number of iterations is 3-4.

### Numerical Performance

An example numerical performance of the iterative antenna training process (protocol) for a 60 GHz SDMA wireless network is provided. The iterative antenna training methods is simulated assuming i.i.d. Rayleigh fading channels between each STA and the common AP, where each STA and the AP is equipped with a 16-element antenna array.

Achievable channel gains are compared for each link for time division multiple access (TDMA) vs. SDMA. In the TDMA case, a first channel time period (e.g., first superframe) is allocated to STA1, during which the iterative antenna training protocol is carried out followed by payload transmission between STA1 and AP. A second channel time period (e.g., second superframe) is then allocated to STA2, during which the iterative antenna training protocol is carried out followed by payload transmission between STA2 and AP.

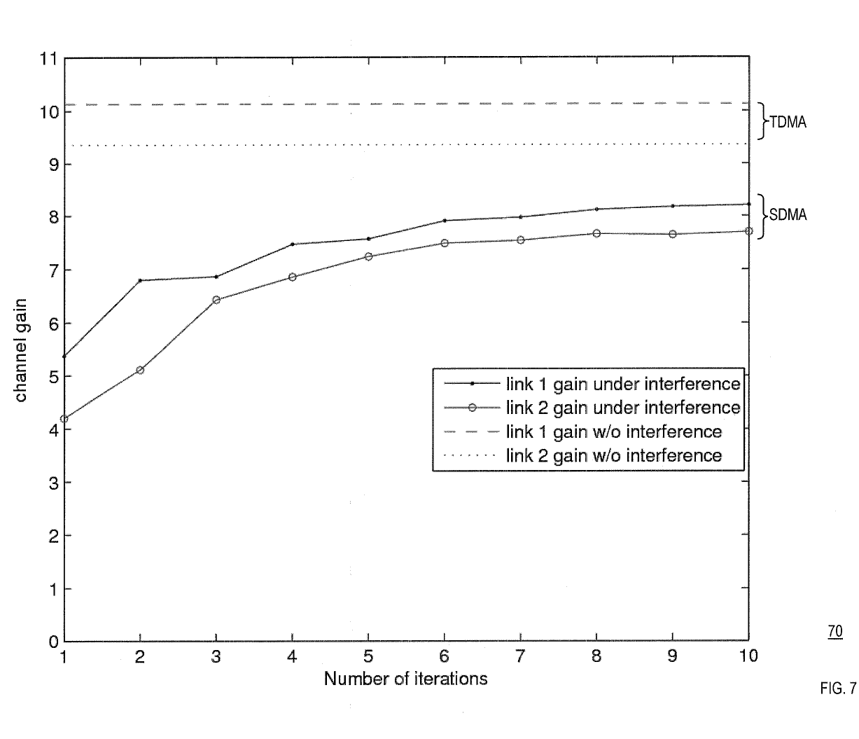

Thus, each individual link (i.e., link 1 for STA1-AP, and link 2 for STA2-AP) does not see interference from the other STA since they the STAs are temporally separated. The achieved channel gains for each link are illustrated in graph 70 of FIG. 7 using dashed lines for a certain pair of channel realizations H₁, H₂. FIG. 7 illustrates numerical performance comparisons according to the legend.

For the SDMA scenario, the same channel realizations are maintained and the iterative antenna training protocol is performed (the achieved channel gains for each link are illustrated in FIG. 7 in solid lines). The achieved gains for both links converge in a few antenna training iterations in the SDMA protocol. Furthermore, most portions of the gains achievable in the TDMA scenario (without interference) may be achieved in the SDMA scenario, via the iterative antenna training process herein.

For TDMA, the achieved channel gain is higher for each individual link because they do not see any interference between each other. Due to the inherent nature of TDMA, only one link is supported in one time unit (can be one superframe or multiple superframes).

For SDMA, the achieved channel gain is lower for each individual link because the STAs experience interference from each other. However, the inherent nature of SDMA informs that the two links are supported simultaneously. Therefore, to appreciate the performance diagram, the proper comparison is for one-dashed-curve (corresponding to a certain link in the TDMA case) to the two-solid-curves-together (corresponding to the concurrent both links in the SDMA case), to surmise the performance difference. Apparently, SDMA provides a much larger channel gain in total than TDMA, which results into larger sum-capacity of SDMA than TDMA. This is aligned with the fundamental result in information theory that TDMA is not the optimal multiple access scheme in general.

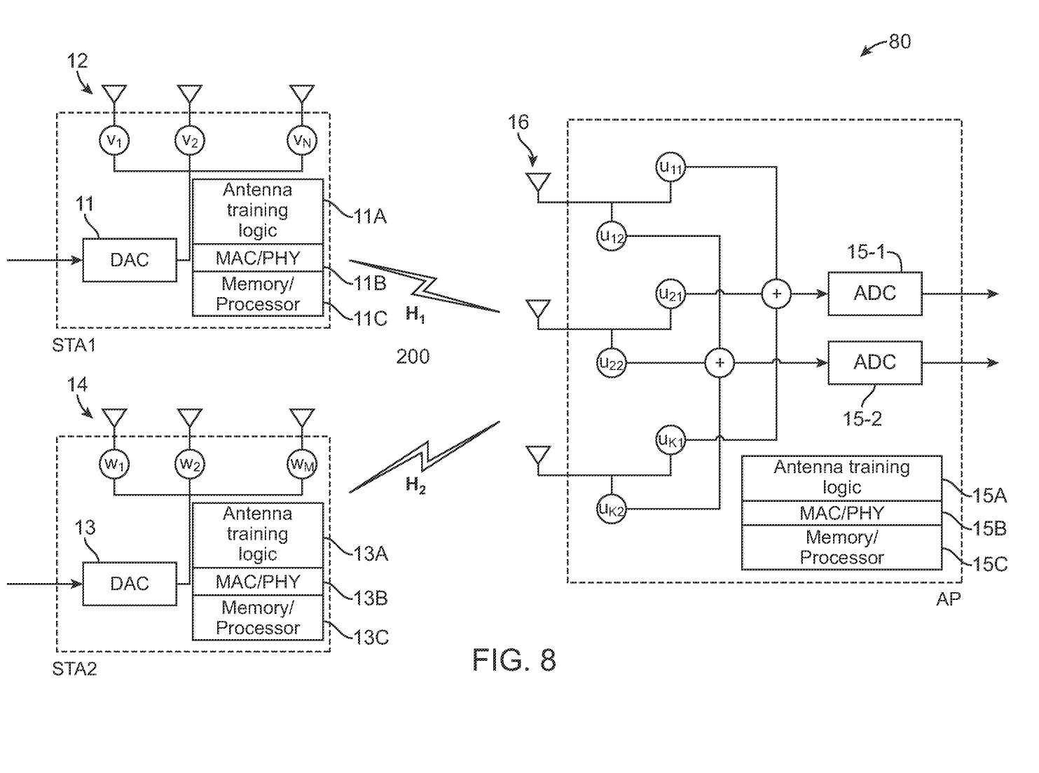

FIG. 8 shows a functional block diagram of a 60 GHz SDMA wireless network 80, according to another embodiment of the invention. The network 80 comprises at least three wireless devices including wireless stations STA1, STA2 and a common access point (AP), similar to FIG. 1. The devices STA1 and STA2 access the AP at the same time using SDMA. Each STA has a single RF chain while the AP has two RF chains to support simultaneous transmissions with the two STAs. STA1 includes an RF chain comprising digital-to-analog converter (DAC) 11 and with an N-element antenna array 12, STA2 includes an RF chain comprising a DAC 13 and M-element antenna array 14, while the AP comprises two analog-to-digital (ADC) converters 15-1, 15-2 and a K-element antenna array 16.

In this example, the STA1 further includes antenna training logic 11A, MAC/PHY layers block 11B and memory/processor block 11C. The antenna training logic 11A is configured as described above for iterative SDMA protocol antenna training and communication. The STA2 further includes antenna training logic 13A, MAC/PHY layers block 13B and memory/processor block 13C. The antenna training logic 13A is configured as described above for iterative SDMA protocol antenna training and communication. The AP further includes antenna training logic 15A, MAC/PHY layers block 15B and memory/processor block 15C. The antenna training logic 15A is configured as described above for iterative SDMA protocol antenna training and communication. Although two stations STA1, STA2 are shown in FIG. 8, the invention is equally applicable to networks including three or more stations accessing an AP.

As such, the invention provides spatial division multiple access in 60 GHz Millimeter Wave communications by estimating optimal transmit beamforming vectors for the STAs and optimal receive beamforming vectors for the AP. Using the iterative antenna training protocol according to the invention, the optimal transmit/receive beamforming vectors are computed without explicit knowledge of the actual wireless channels. For a 60 GHz network, antenna beamforming coefficients (i.e., beamforming vectors) are properly trained in advance to form desirable spatial beam patterns for the AP and the STAs for the spatial division multiple access protocol, according to an embodiment of the invention.

Embodiments of the present invention are applicable in 57-64 GHz frequency band and may be utilized in WirelessHD, WiGig, international standards: IEEE 802.15.3c, IEEE 802.11ad, and ECMA 387 standards. A 60 GHz network has the potential to provide Gbps throughput over a short range. Transceiver beamforming bridges the link budget deficit in 60 GHz. Directional transmissions is provided by transceiver beamforming. SDMA is used for directional communications in 60 GHz wireless networks.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A communication method in a network of wireless devices including multiple stations (STAs) and an access point (AP), each wireless device including plural antennas, the method comprising:
multiple stations accessing the access point at the same time using a spatial division multiple access (SDMA) protocol; and
the SDMA protocol including performing an iterative antenna training process for obtaining principle singular vectors for beamforming communication over a wireless channel without explicit knowledge of the channel.

2. The method of claim 1 wherein:
the wireless network comprises a 60 GHz Millimeter Wave wireless network; and
the iterative antenna training process comprises acquiring antenna beamforming vectors for the stations accessing the access point using iterative beamforming.

3. The method of claim 2 wherein the iterative antenna training process further comprises:
performing power iterations to estimate the beamforming vectors for the stations and the access point.

4. The method of claim 3 wherein the iterative antenna training process further comprises:
performing similar power iteration processes in estimating the beamforming vectors for the stations and the access point.

5. The method of claim 4 wherein the iterative antenna training process further comprises:
the stations transmitting training sequences to the access point at the same time using orthogonal spreading sequences for each station to reduce interference, by repeating destination beamforming vector training and source beamforming vector training multiple times, such that in each iteration step: a normalized beamforming vector t is used for transmission to train a destination beamforming vector, and a normalized beamforming vector outcome r is used for transmission to train a source beamforming vector, and a normalized beamforming vector outcome t is used in the next iteration for transmission to train destination beamforming vector.

6. The method of claim 5 wherein the iterative antenna training process further comprises repeating STA-side antenna training and AP-side antenna training steps multiple times, such that:
normalized interim transmit beamforming vectors v, w obtained in each iteration for the first and second stations, respectively, are used in AP-side antenna training step in a next step; and
normalized interim receive beamforming vectors u₁, u₂ obtained in each iteration step for the first and second stations, respectively, are used in STA-side antenna training in a next iteration step.

7. The method of claim 6 wherein each iteration step includes: transmitting a vector t in a given time slot includes sending a predetermined pseudo random sequence spatially spread by vector t, and transmitting a vector r in a given time slot includes sending a predetermined pseudo random sequence spatially spread by vector r.

8. The method of claim 7 wherein:
a first transmitting station includes an N-element antenna array, and a second transmitting station includes an M-element antenna array, and an AP includes a K-element antenna array;
a training step includes station side training by:
repeatedly transmitting from a first radio frequency (RF) chain of an AP the same initial receive beamforming vector u₁ for a first station for N consecutive channel time slots, while each time slot is spread by a pseudo random spreading sequence p₁;
repeatedly transmitting from a second RF chain of an AP the same initial receive beamforming vector u₂ for a second station for M consecutive channel time slots, while each time slot is spread by a pseudo random spreading sequence p₂, wherein p₂ is essentially orthogonal to p₁;
the first station using I_{N} as a receive beamforming vector over N time slots, while performing de-spreading using p₁;
the second station using I_{M} as a receive beamforming vector over M channel time slots, while performing de-spreading using p₂; and
collecting the received samples, and estimating transmit beamforming vectors v, w for first and second stations, respectively.

9. The method of claim 8 wherein:
v=H′₁(u₁⊕u₂)+noise,
w=H′₂(u₁⊕u₂)+noise.

10. The method of claim 7 wherein a training step includes AP-side training by:
repeatedly transmitting the same normalized vector v over K channel time slots from the first station while each time slot is spread by a pseudo random sequence q₁;
repeatedly transmitting the same normalized vector w over K channel time slots from the second station while each time slot is spread by a pseudo random sequence q₂, that is essentially orthogonal to q₁;
in a first RF chain of the AP using I_{K} as the receive beamforming vector over K time slots while de-spreading using q₁;
in a second RF chain of the AP using J_{K} as the receive beamforming vector over K time slots while de-spreading using q₂, wherein J_{K} is selected as an orthogonal matrix such that each column of J_{K} is orthogonal to the corresponding column of I_{K};
collecting and rearranging samples for estimating vectors u₁, u₂; and
using the normalized beamforming vectors u₁, u₂ in the next iteration of station-side antenna training

11. The method of claim 10 wherein:
u₁=H₁v+interference+noise,
u₂=H₂w+interference+noise.

12. A wireless communication system, comprising:
a wireless network of plural wireless devices including plural stations (STAs) and an access point (AP), each wireless device including plural antennas; and
the multiple stations accessing the access point at the same time using a spatial division multiple access (SDMA) protocol, the SDMA protocol including performing an iterative antenna training process involving the stations and the access point, for obtaining principle singular vectors for beamforming communication over a wireless channel without explicit knowledge of the channel.

13. The system of claim 12 wherein:
the wireless network comprises a 60 GHz Millimeter Wave wireless network; and
the stations and the access point are configured for iterative antenna training by acquiring antenna beamforming vectors for the stations accessing the access point using beamforming.

14. The system of claim 13 wherein the stations and the access point are configured for iterative antenna training using power iterations to estimate the beamforming vectors for the stations and the access point.

15. The system of claim 14 wherein the stations and the access point are configured for performing similar power iteration processes in estimating the beamforming vectors for the stations and the access point.

16. The system of claim 15 wherein the stations and the access point are configured for iterative antenna training such that:
the stations transmit training sequences to the access point at the same time using orthogonal spreading sequences for each station to reduce interference, by repeating destination beamforming vector training and source beamforming vector training multiple times, such that in each iteration step: a normalized beamforming vector t is used for transmission to train a destination beamforming vector, and a normalized beamforming vector outcome r is used in a next step for transmission source beamforming vector training, and a normalized beamforming vector outcome t is used in the next iteration for transmission destination beamforming vector training.

17. The system of claim 15 wherein the stations and the access point are configured for iterative antenna training, comprising repeating STA-side antenna training and AP-side antenna training multiple times, such that:
normalized interim transmit beamforming vectors v, w obtained in each iteration for the first and second stations, respectively, are used in AP-side antenna training in a next step; and
normalized interim receive beamforming vectors u₁, u₂ obtained in each iteration for the first and second stations, respectively, are used in STA-side antenna training in a next iteration.

18. The system of claim 17 wherein in each iteration, transmitting a vector t in a given time slot includes sending a predetermined pseudo random sequence spatially spread by vector t, and transmitting a vector r in a given time slot includes sending a predetermined pseudo random sequence spatially spread by vector r.

19. A wireless station (STA), comprising:
a radio frequency (RF) chain and plural antennas, configured for access to an access point (AP) in a wireless network at the same time as another wireless device, using a spatial division multiple access (SDMA) protocol; and
antenna training logic configured for performing an iterative antenna training process for obtaining principle singular vectors for beamforming communication over a wireless channel without explicit knowledge of the channel.

20. The wireless station of claim 19 wherein the wireless network comprises a 60 GHz Millimeter Wave wireless network, and the antenna training logic is configured for iterative antenna training by estimating antenna beamforming vectors for accessing the access point using beamforming.

21. The wireless station of claim 20 wherein the antenna training logic is configured for power iterations by repeating STA-side antenna training in cooperation with an AP-side antenna training, such that:
a normalized interim transmit beamforming vector obtained in each iteration for the wireless station is used in AP-side antenna training in a next iteration; and
a normalized interim receive beamforming vector obtained in each iteration for the wireless station is used in STA-side antenna training

22. A wireless access point (AP), comprising:
multiple radio frequency (RF) chains and multiple antennas, configured for access by multiple wireless stations (STAs) at the same time in a wireless network, using a spatial division multiple access (SDMA) protocol; and
antenna training logic configured for performing an iterative antenna training process for obtaining principle singular vectors for beamforming communication over a wireless channel without explicit knowledge of the channel.

23. The wireless access point of claim 22 wherein the wireless network comprises a 60 GHz Millimeter Wave wireless network, and the antenna training logic is configured for iterative antenna training by estimating antenna beamforming vectors using transceiver beamforming power iterations by repeating AP-side antenna training in cooperation with an STA-side antenna training, such that:
a normalized interim transmit beamforming vector obtained in each iteration for each wireless station is used in AP-side antenna training in a next iteration; and
a normalized interim receive beamforming vector obtained in each iteration for each wireless station is used in STA-side antenna training

24. The wireless access point of claim 23, wherein the STAs transmit training sequences to the AP at the same time using orthogonal spreading sequences for each STA to reduce interference, by repeating destination beamforming vector training and source beamforming vector training multiple times, such that in each iteration step: a normalized beamforming vector outcome r is used in a next step for transmission source beamforming vector training, and a normalized beamforming vector outcome t is used in the next iteration for transmission destination beamforming vector training

25. The wireless access point of claim 24 wherein the antenna training logic is configured such that each iteration comprises transmitting a vector t in a given time slot by sending a predetermined pseudo random sequence spatially spread by vector t, and transmitting a vector r in a given time slot by sending a predetermined pseudo random sequence spatially spread by vector r.
